(19) United States
(12) Patent Application Publication
(10) Pub. No.: US 2014/0272502 A1
(43) Pub. Date: Sep. 18, 2014

(54) Golf Cart Battery System

(71) Applicant: Gene D. Bingaman, Shingle Springs, CA (US)

(72) Inventor: Gene D. Bingaman, Shingle Springs, CA (US)

(21) Appl. No.: 14/213,746

(22) Filed: Mar. 14, 2014

Related U.S. Application Data
(60) Provisional application No. 61/791,951, filed on Mar. 15, 2013.

(51) Int. Cl. H01M 10/48; B23P 11/00; H01M 2/10

(52) U.S. Cl. CPC H01M 10/482; H01M 2/1083; B23P 11/00; H01M 10/484
USPC 429/91; 429/159; 29/426.5

(57) ABSTRACT

A battery includes an integrated or single case structure with internal through wall connections of all cells to provide the battery with an output voltage that is the full voltage required for a golf cart, e.g., about 36 to 72 volts. The integrated case may be made from plastic or similar material and includes lift features that permit replacement of the battery using a mechanical lift system. The battery may further include one or more filler tubes, each containing a float that can be seen though a cap on the tube when liquid is at a desired level and cannot be seen though the cap when liquid is at a low level.

### CROSS-REFERENCE TO RELATED APPLICATION

This patent document claims benefit of the earlier filing date of U.S. provisional patent application 61/791,951, filed Mar. 15, 2013, which is hereby incorporated by reference in its entirety.

### BACKGROUND

Golf carts often employ multiple batteries that are connected together in series to provide a desired voltage and power storage. A currently common configuration employs six 8-volt batteries serially connected to provide a 48 volt power supply. Systems with serially connected batteries have a number of potential problems. In particular, the batteries are generally enclosed in a compartment below the seat or another portion of the golf cart. As a result, cables that connect to posts on top of the batteries have the potential for shorting against the portions of the golf cart that are over the batteries. Additionally, the multitude of connections of the cables to the batteries may be subject to corrosion, which is common for lead-acid type batteries. As a result, battery system failures may occur and the connections of the batteries need to be maintained.

### BRIEF DESCRIPTION OF THE DRAWINGS

FIG. 1 shows a top view of a golf cart battery illustrating the arrangement of cells and terminals in the battery.

FIG. 2 shows a side view of the golf cart battery of FIG. 1.

FIG. 3 shows a nylon battery lifter that may be used with a cherry picker, fork lift or other lifting device to install and remove a golf cart battery.

FIG. 4 shows an electric golf cart employing a single battery to power locomotion and a mechanical lift system for installing or removing the battery.

FIG. 5 shows a battery cap with a window for viewing of a level indicator.

FIG. 6 shows a battery system including a window cap, a bent full tube, and a floating ball.

The drawings illustrate examples for the purpose of explanation and are not of the invention itself. Use of the same reference symbols in different figures indicates similar or identical items.

### DETAILED DESCRIPTION

In one implementation, a battery includes an integrated or single case structure with internal through-wall connections of all cells to provide the battery with an output voltage that is the full voltage and amperage required for locomotion of an electric golf cart, e.g., about 48 volts or in a range from 36 to 72 volts and a peak amperage on the order of 100 amps or more. The battery can thus eliminate the need for a large number of interconnecting cables. For example, current golf carts commonly employ six 8V batteries and external serial wire or cable connections that are prone to corrosion and failure. The corrosion from such battery connectors may be a regulated or hazardous material, so that the through-wall connectors may also provide a more environmentally friendly solution by reducing corrosion, particularly since mobile systems such as golf carts could spread the corrosion byproducts during travel. Eliminating the interconnecting cables may also improve safety by reducing the risk of fire caused by electrical shorting of the interconnecting cables.

FIG. 1 shows an example of a battery 100 containing electrolytic cells 110 arranged in a U-shaped pattern and electrically connected using through-wall connectors 150 that extend through walls that separate electrolytes in respective cells 110. Through-wall connectors 150 can be of the same type employed in automotive batteries and remain within the interior or battery 100. Alternatively, top or side straps as used for electrical connections between cells in forklift batteries could be employed in battery 100.

The U-shaped pattern of cells 100 allows external terminals 120 and 130, e.g., posts or diesel-type battery connectors, to be located close to each other, preferably on a side of the battery case 140. Terminals 120 and 130 being close together on the side of case 140 provides ease of connection and reduces the chance of electrical shorting, but terminals 120 and 130 could alternatively be more widely separated or located on a top surface of battery 100. External terminals 120 and 130 may be connected to the electrical system of a golf cart to provide output power for locomotion of the golf cart. Battery 100 can also be charged through terminals 120 and 130 using a conventional charging system that may be in the golf cart and plugged into a standard AC outlet.

Each cell 110 may be a conventional lead-acid wet or deep-cycle cell and has a positive and negative terminal, and through-wall conductive interconnects 150 connect positive or negative terminals of each cell 110 to negative or positive terminals of an adjacent cell 110 in the series connection or to external terminal 120 or 130. The output voltage of the serially connected cells 110 is thus about equal to the sum of the voltages of the cells. For example, if each cell 110 provides a voltage or about 2.1 volts as do conventional lead-acid cells and if battery 100 includes twenty-four cells 110 connected in series, a total output voltage may be about 50.4 volts between external terminals 120 and 130. Such a battery may be commonly referred to as a “48-volt battery” since the output voltage is four times the 12.6-volt output voltage of a “12 volt” automotive battery.

Battery case 140 may be made of an organic insulating material such as propylene, resin, plastic, or hard rubber and is shaped to form a bottom, a top, side walls, as well as interior walls that separate compartments for cells 110. In one implementation, a 48-volt, integrated battery 100 has a length L of about thirty inches, a width W of about fourteen inches, and a height H of about twelve inches. A 48-volt battery of that size may be heavy (e.g., 300 to 400 lbs) when compared to 12-volt automotive batteries or current 8-volt golf cart batteries. Integrated case 140 and the lower risk of shorting allows more area for active elements of cells 110 and may allow cells 110 to be taller than might otherwise be safely accommodated in the battery compartment of a golf cart. As a result, battery 100 may provide a larger capacity, e.g., about 25% more amp-hours than do multi-battery systems, so that a golf cart using battery 100 may be able to travel further with less charging than would be required if the golf cart used a conventional multi-battery system.

An integrated golf cart battery, which as disclosed may weigh 300 to 400 lbs, is still light enough for use an organic compound such as plastic or hard rubber in case 140. In particular, a 48-volt golf cart battery can employ a case that is made of organic compound, e.g., plastic or hard rubber, with the case being strong enough to withstand the normal stress movement, installation, use, and removal without requiring additional structural support of the top, sides, or bottom of the case. In particular, installation or removal of the battery can employ a lift system that engages lift fixtures on the case but relies solely on the case to maintain structural integrity of the battery. In contrast, some forklift batteries may be heavier still (e.g., 1000 to 2500 lbs) and typically require metal cases or support to withstand normal use, installation, or removal.

Battery case 140 may further include lift features 210 as shown in FIG. 2 that are shaped for use with a mechanical lift system that may be used for installation or removal of a battery in a golf cart. For example, case 140 may include four lift features 210, e.g., molded plastic lifting points, located at top-center at each of the four side walls of case 140. Each lift feature 210 may be a tab containing one or more holes.

FIG. 3 shows a battery lifter 300 including four straps 320 with connectors 310 such as hooks that can engage the lift features 210 of the battery case 140. Straps 320 may, for example, be single-ply or multiple-ply nylon straps. For example, single-ply nylon straps one inch or wider may provide lifter 300 a lifting capacity many times the weight of a 400-lb battery. A loop 330 that may be formed from or connected to straps 320 on lifter 300 can be sized so that a lifting device such as a cherry picker, an automotive engine hoist, a boom, or a fork lift can engage loop 330 and apply force to lift a battery 100 out of a golf cart or to lower a battery 100 into a golf cart.

Battery lifter 300 may be altered in a variety of ways to provide a removable lifter for temporarily connecting a golf cart battery to lifting machinery. In particular, although the illustrated implementation of lifter 300 use straps to connect connectors 310 to loop 330, many other flexible structures that have sufficient tensile strength could be employed. For example, straps 320 could be replaced by rope, cable, or chain.

FIG. 4 shows a system including a golf cart 410. Golf cart 410 may be a conventional electrical golf cart having a battery compartment 412 for a battery system that powers the electrical system of golf cart 410 and particularly powers an electrical drive motor 414. As noted above, golf carts currently employ a battery system including multiple series connected batteries, and compartment 412 may be sized to accommodate multiple batteries and interconnecting cables. Accordingly, compartment 412 must be large enough to provide space between individual batteries, for connecting cables and battery terminals, and to provide a margin to prevent shorting when a lid for compartment 412 is closed. In FIG. 4, golf cart 410 uses a single battery 100, which fits in compartment 412 and powers electrical drive motor 414. Since battery 100 does not require serial connectors between individual batteries, battery 100 can be made larger in some dimensions, e.g., height, without risk of shorting. Battery 100 may thus provide more amp-hours of storage using the same battery technology as a multi-battery system. However, battery 100 may be too heavy for a person to carry, install in golf cart 410, or remove from golf cart 410. A cherry picker, engine hoist, or similar lifting equipment 420 can engage a lifter 300 that may be temporarily attached to raise or lower battery 100, e.g., for installation into or removal from compartment 412.

Batteries such as described above can include one or more systems that permit determination of the level of acid or other liquid within the battery or within individual cells of a battery. FIG. 2, for example, shows an implementation of battery 100 including battery gang caps 220, each of which is fitted to multiple cells 110 of battery 100. Each battery gang cap 220 may include one or more systems for viewing the levels of liquid in the cells 110. For example, FIG. 5 shows a top view of a cap 500 that may fit on a tube 610 shown in FIG. 6 to provide a view system suitable for gang caps 220.

Cap 500 has a transparent top window 510 or, alternatively, cap 500 may be made entirely of transparent material. Cap 500 may be permanently attached to tube 610 or may be removable. For example, cap 500 may be glued to or molded on tube 510 to avoid releasing liquid from battery case 140. Alternatively, cap 500 may be removably attached, e.g., threaded or pushed onto, tube 610, so that cap 500 may be removed to add liquid to battery case 140.

Tube 610 extends into the battery case 140 and may extend into acid or other liquid contained in a cell of case 140. Accordingly, a battery may include one tube 610 per cell, and a 48-volt battery may include twenty-four similar tubes respectively for twenty-four cells having separate fluid levels. Tube 610 may be transparent or opaque and may include holes or other means that permit fluid to flow through the walls of tube 610. Tube 610 contains one or more balls or other types of float 620 that is trapped in tube 610 and is lighter than and therefore floats at the surface of the liquid in battery case 140 and tube 610. A bottom of tube 610 may be generally open as shown in FIG. 6 so that liquid within case 140 can enter tube 610 and lift float 620, but the bottom of tube 610 may include some type of obstruction, screen, or narrowing 615 that prevents float 620 from passing out of the bottom of tube 610. Float 620 may be a bright color ball or have a color with a high contrast from its surrounding such as tube 610. For example, float 620 may be bright yellow and case 140 or tube 610 may be black or red. When the liquid in a cell has a desired level 630, float 620 floats toward the top of tube 610 and can be seen through the transparent window 510 in cap 500. As the fluid level drops, float 620 moves further from window 510 and becomes more difficult to see. Further, tube 610 may be bent or all or a portion of tube 610 may be at a non-zero angle, e.g., 45 degrees, from vertical or the sides of battery case 140. In particular, float 620 may move horizontally away from the center or view portion of cap 500 as float 620 moves vertically downward with dropping fluid level. As a result, float 620 moves away from being directly under window 510, and when the liquid in case 140 is at a low level 640, float 620 may not be visible through cap 500 since float 620 has moved out of the line of sight through cap 500.

As described herein, implementations of a golf cart battery system can employ a single integrated battery without the need for external interconnecting cables or conductors that were previously employed in multi-battery systems. Accordingly, the risk of electrical shorts and maintenance issues associated with corrosion, particularly at a large number of battery terminals, can be reduced. The resulting integrated battery, while being too heavy for a single person to easily lift, is still light enough that the case of the integrated battery can be made of the same organic materials used in current automotive and golf cart batteries. Further, lift systems and processes can be easily employed so that an integrated golf cart battery can be moved, installed in a golf cart, or removed from a golf cart without undue trouble or expense.

Although particular implementations have been disclosed, these implementations are only examples and should not be taken as limitations. Various adaptations and combinations of features of the implementations disclosed are within the scope of the following claims.

What is claimed is:

1. A golf cart battery comprising:
a case of an organic insulating material;
a plurality of electrolytic cells in the case;
a plurality of through-wall connectors extending through internal walls of the case and connecting the electrolytic cells in series; and
a pair of external terminals on the case and providing output power capable of driving locomotion of a golf cart.

2. The golf cart battery of claim 1, wherein the electrolytic cells are arranged in a U-shaped configuration within the case.

3. The golf cart battery of claim 2, wherein the external terminals are on an exterior of a side wall of the case and connected to the electrolytic cells at ends of the U-shaped configuration.

4. The golf cart battery of claim 1, wherein the output power is at a voltage in a range from 36 volts to 72 volts.

5. The golf cart battery of claim 1, wherein the golf cart battery is a 48-volt battery.

6. The golf cart battery of claim 1, wherein the case comprises a plurality of lift features shaped to engage a mechanism for lifting the battery out of a golf cart.

7. A process comprising:
providing an integrated golf cart battery providing a voltage for locomotion of a golf cart and having a case made of an organic material;
engaging a lifter in lift features of the case; and
lifting on the lifter to install or remove the battery in a golf cart.

8. The process of claim 7, wherein lifting on the lifter comprises operating a lift system selected from a group consisting of a cherry picker, an engine hoist, a boom, or a fork lift.

9. A system for viewing a level of a liquid in a battery, the system comprising:
a tube positioned to extend into the liquid within the battery;
a float within the tube; and
a cap providing a view into the tube, wherein:
the tube is shaped or oriented so that the float floats on the liquid at a position within the view when the liquid is at a desired level and so that the float moves horizontally out of the view as the float moves vertically down the tube.

10. The system of claim 9, wherein at least a portion of the tube extends into the liquid at a non-zero angle from vertical.
